(19) United States
(12) Patent Application Publication
(10) Pub. No.: US 2016/0361224 A1
(43) Pub. Date: Dec. 15, 2016

(54) A PORTABLE COMPRESSION DEVICE

(71) Applicant: Raj RAMAKRISHNA, Wollongong, New South Wales (AU)

(72) Inventors: Raj Ramakrishna, Wollongong (AU); Stephen Muller, Blakehurst (AU)

(21) Appl. No.: 15/116,875

(22) PCT Filed: Feb. 6, 2015
(86) PCT No.: PCT/AU2015/000065

§ 371 Date: Aug. 5, 2016

(30) Foreign Application Priority Data
Feb. 7, 2014 (AU) 2014900369

(51) Int. Cl. A61H 9/00

(52) U.S. Cl. CPC A61H 9/0078; A61H 2201/165; A61H 2201/0157; A61H 2209/00; A61H 2201/5002; A61H 2201/5015; A61H 2201/5038; A61H 2205/106; A61H 2201/5043

(57) ABSTRACT

The present invention provides a portable compression device (10) for selectively applying a compressive force to a limb of a user (50). The device includes one or more inflatable bladders (18, 20, 22) and a pumping means (24, 26, 28) for selectively inflating and deflating each bladder thereby selectively applying an inwardly directed compressive force to the limb. The one or more inflatable bladders and the pumping means are disposed on a base assembly (12).

### FIELD OF THE INVENTION

The present invention relates to a portable device for applying controlled and adjustable compressive force to a limb of a patient. The device is described primarily in the context of providing compression to a portion of a lower limb, such as a calf, although it will be appreciated that the device is not limited to this field of use.

### BACKGROUND OF THE INVENTION

The following discussion of the prior art is intended to facilitate an understanding of the invention and to enable the advantages of it to be more fully understood. It should be appreciated, however, that any reference to prior art throughout the specification should not be construed as an express or implied admission that such prior art is widely known or forms part of common general knowledge in the field.

This invention relates to improvements in the care and treatment of patients who are at high risk of/or undergoing treatment for venous insufficiency, deep vein thrombosis (DVT) or chronic venous disorders (CVD). It can also be used by the general public in situations where they may be required to sit or remain immobile for extended periods, such as would occur on long plane trips or other such transport.

Around 40 to 50% of patients with lower limb DVT may develop post thrombotic sequelae within two years. The signs and symptoms include from minor features such as pigmentation, varicosities, pain and swelling to major symptoms of intractable oedema, chronic pain and leg ulcers. Meta-analysis recommended that all patients with DVT should be prescribed graduated compression stockings or intermittent pneumatic compression in patients with severe oedema.

Compression therapy by intermittent pneumatic compression stockings or PEG bandage is used to treat thromboprophylaxis and for chronic venous disease and its complications. The degree of compression varies according to patient's individual factors. Compression therapy aims to increase venous and lymphatic return, reduce oedema and venous pressure in the limb.

Existing devices which provide compressive forces to a limb of a patient are typically large cumbersome machines which are primarily used within the hospital environment. Due to their large dimensions and reliance on (240/110V) mains power, these hospital-based devices are not ambulatory and hence cannot be taken home by the patient for continued care or used by people in transit.

Recent evidence suggests that use of compression stockings do not reduce thrombotic complications to any significant degree. Part of the problem appears to be difficulties in using the stockings and hence long term compliance, especially in the elderly with limited mobility and family support. Hence compliance is a major issue with the stockings. Further devices such as Venowave squeeze the calf muscle externally like a rolling pin.

It is an object of the present invention to overcome or ameliorate at least one of the disadvantages of the prior art, or to provide a useful alternative.

### SUMMARY OF THE INVENTION

The present invention provides a portable compression device for selectively applying a compressive force to a limb of a user, the device including:

one or more individually inflatable bladders; and

a pumping means adapted to selectively inflate and deflate each bladder thereby selectively applying an inwardly directed compressive force to said limb,

wherein the one or more inflatable bladders and the pumping means are disposed on a base assembly.

In one embodiment, the base assembly includes a first base plate and a second base plate.

In one embodiment, the one or more inflatable bladders are disposed on the first base plate.

In one embodiment, the pumping means is disposed on the second base plate.

In one embodiment, the portable compression device includes a power means disposed on the second base plate.

In one embodiment, the portable compression device includes a control means operatively associated with the pumping means, the control means being located on the second base plate.

In one embodiment, each bladder is adapted for independent inflation and deflation.

In one embodiment, the pumping means includes one or more variable speed air pumps.

In one embodiment, each variable speed air pump is in direct fluid communication with a corresponding inflatable bladder.

In one embodiment, each air pump is adapted to variably inflate each or all bladders to a pressure in the range of between 10 and 80 mmHg.

In one embodiment, the portable compression device includes one or more valves operatively associated with the pumping means.

In one embodiment, the one or more bladders include three interconnected inflatable bladders.

In one embodiment, the pumping means is adapted to sequentially inflates each bladder during use of the device.

In one embodiment, each bladder is adapted to be substantially wrapped around the limb of the user and apply the compressive force substantially to the periphery of the limb.

In one embodiment, each bladder extends only partially around the periphery of the limb and wherein at least two bladders are arranged adjacent to one another such that in use adjacent bladders in combination extend substantially around the periphery of the limb.

In one embodiment, the control means includes a user display and user controls.

In one embodiment, one or more fasteners are used to secure the one or more bladders around the limb.

In one embodiment, the fasteners include Velcro, buttons, zippers, press studs or a combination thereof.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

### BRIEF DESCRIPTION OF THE DRAWINGS

Preferred embodiments of the invention will now be described, by way of example only, with reference to the accompanying drawing in which:

FIG. 1 is an perspective view of a portable device for selectively applying a compressive force to a limb of a user, according to one embodiment of the invention;

FIG. 2 is an exploded perspective view of the device of FIG. 1;

FIG. 3 is a perspective view of the device of FIG. 1 about to be strapped to a limb of a user;

FIG. 4 is a perspective view of the device of FIG. 1, being strapped to a limb of a user;

FIG. 5 is a perspective view of the device of FIG. 1, in operation strapped to a limb of a user;

FIG. 6A is a schematic view of the device of FIG. 1, in wired connection with a desktop computer, tablet or smart phone;

FIG. 6B is a schematic view of the device of FIG. 1, in wireless connection with a desktop computer, tablet or smart phone; and

FIG. 7 is a partly exploded perspective view of the device of FIG. 1.

### PREFERRED EMBODIMENTS OF THE INVENTION

Exemplary embodiments of the present invention will now be described in detail with reference to the accompanying drawings. In the drawings, the same elements are denoted by the same reference numerals throughout. In the following description, detailed descriptions of known functions and configurations incorporated herein have been omitted for conciseness and clarity.

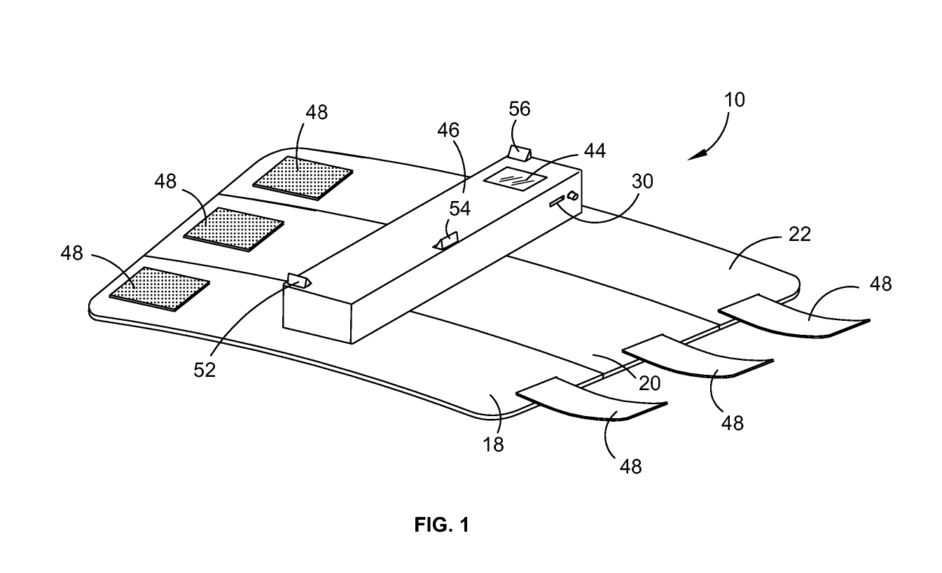

Referring to the accompanying drawings and initially FIG. 1, there is provided a portable device 10 for selectively and sequentially applying a compressive force to a limb of a user through one or more inflatable bladders. The limb pressure applied by the bladders is a modulated external pneumatic pressure for treating ailments such as deep vein thrombosis or chronic venous disorders. Due to the device being portable, it can be advantageously used at home while resting or during normal activities or during transit and the patient does not have to be supervised by a doctor or other medical professional during use.

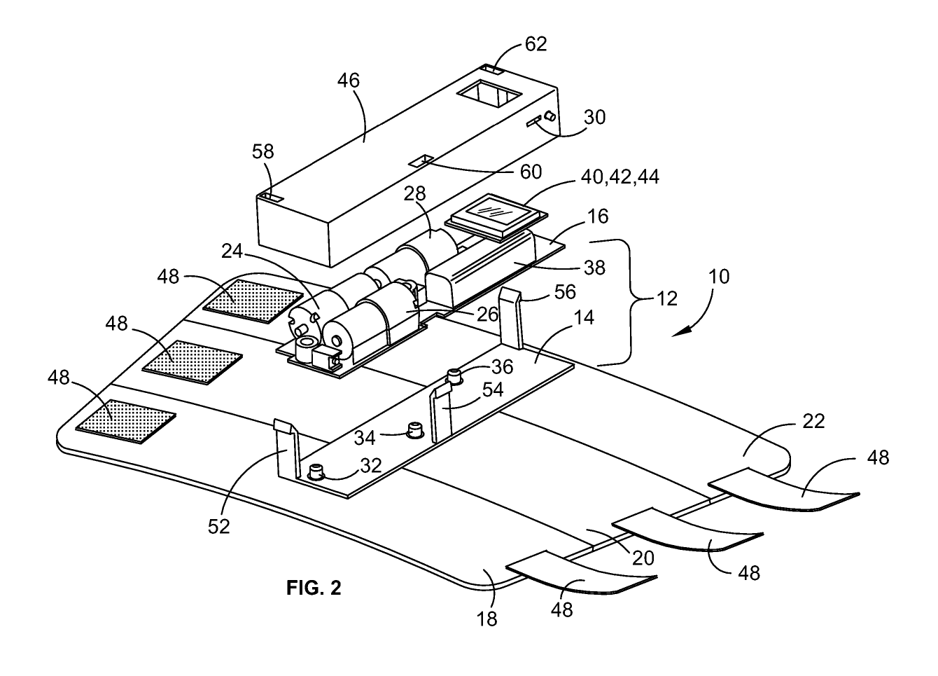

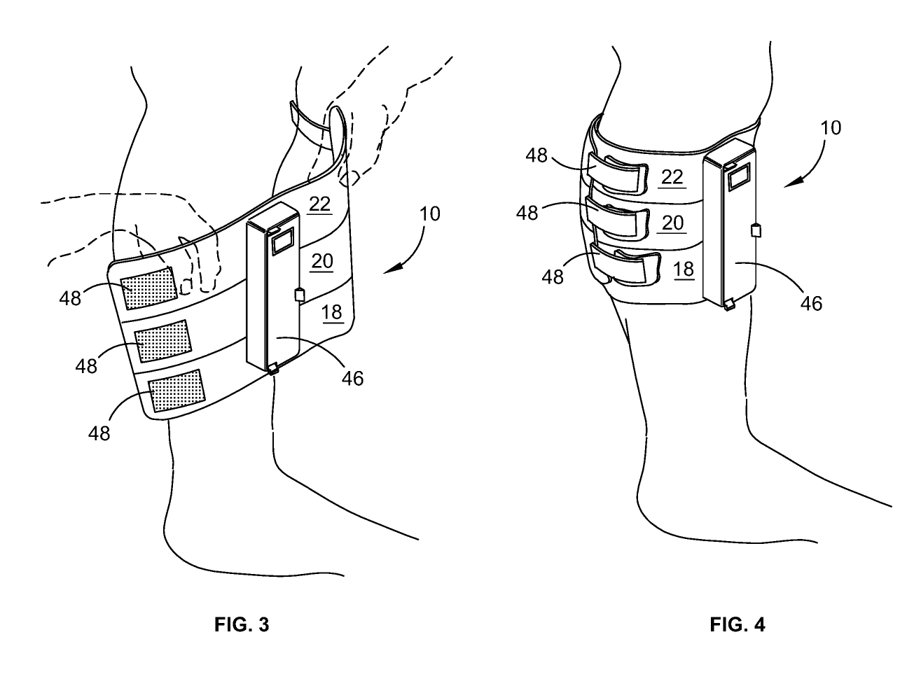

With reference to FIG. 2, the device 10 includes a base assembly 12 having a first and second base plates. In the illustrated embodiment the first and second base plates are respectively shown as lower base plate 14 and upper base plate 16. Three interconnected inflatable bladders 18, 20 & 22, are provided on the underside of lower base plate 14 to provide the limb pressure. The bladders are flexible enough in their deflated state to be able to be wrapped around a patient's limb as shown in FIGS. 3 to 5.

In other not shown embodiments, more bladders may be used and they may or may not be physically connected. In a further embodiment, only a single inflatable bladder is used to apply the sequential pressure.

Further, while in the illustrated embodiment the bladders are arranged such that they are laterally extending with respect to the longitudinal axis of the lower base plate 14, in other not shown embodiments, the bladders may be longitudinally extending. In other embodiments, any number of bladders may be provided, shaped and disposed such that selective positional pressure along the longitudinal and lateral axes of the limb may be provided. For example, in the embodiment depicted in FIG. 1, each bladder 18, 20 or 22, may be split into a number of laterally spaced, individually inflatable/deflateable discreet segments thereby defining an array of individual bladders that can apply selective individual pressures to any portion of the limb covered by the bladders.

Returning to FIGS. 1 and 2, three variable speed air pumps 24, 26 & 28 are mounted on the upper base plate 16. Each air pump is fluidly connected to a corresponding air bladder via fluid nipples 32, 34 & 36 extending through the lower base plate via corresponding apertures to corresponding bladders. The nipples 32, 34 & 36 are ideally formed from a resilient material such as plastic, and are heat sealed in position in the mounting base and an aperture in each bladder. Upon direct engagement between the fluid nipples and supply ports in their corresponding air pumps, an air tight seal is formed. The fluid nipples may include clip formations at their ends, which engage with corresponding formations in the air pump supply ports. This configuration allows the bladders to be replaced if required.

The arrangement of device 10 is such that the air pumps selectively and individually inflate and deflate each air bladder according to a predetermined order, or simultaneously, so as to apply a sequence of inwardly directed individual, or combined, compressive forces to the limb of the user.

A power means in the form of one or more rechargeable batteries 38, is mounted to the upper base plate 16. In one embodiment, the batteries allow up to at least 8 hours of continuous operation. The device is also ideally configured to connect to mains power for battery recharging and/or operation of the device via a USB port 30 and supplied with a +5V, 1 A mains/USB charger. Advantageously, having its own power source makes the device of the present invention usable in any location and during transit, such as during air travel.

A control system 40 including circuit board and microprocessor 42 is further provided on the upper base plate 16 so as to control the operation of the variable speed air pumps 24, 26 & 28. In these respects, the air pumps are adapted to selectively provide air pressure anywhere in the range of between 10 and 80 mmHg to each bladder depending on the sequence requirements and programming provided by the control system. The pumps 24, 26 & 28 are ideally variable speed pneumatic pumps and include their own individual motor drives, however, it should be understood that any suitable pumps may be used. Furthermore, it will be appreciated that adjacent bladders may have different pressure requirements depending on the user selection or programming. For example, in one application, the maximum pressures achieved in bladders will be 30, 60 or 80 mmHg.

The reason for such a wide variation in pressure is that research has found that a single maximum pressure is not suitable to all patients. Some patients require a lower pressure and others require a higher pressure to control their symptoms of leg swelling and pain.

It will be appreciated that other arrangements are possible, whereby one a single pump is connected via a fluid conduit to more than one bladder, or vice versa. In such arrangements, valves, or other means may be used to selectively inflate and deflate the fluidly connected bladders. In this way, individually controlled additional bladders may be accommodated using a single air pump.

As illustrated, the control system 40 is located as part of the device 10. In other embodiments, at least part of the control system could be provided in a control unit located separately from the base assembly of the device. This separate control unit may, for example, be part of a waist pack to be worn by the user. The device may also include an air bleed system (not shown) controlled by the control system for deflating each bladder.

The control system 40 further includes a user interface shown in FIGS. 1 and 2 as backlit LCD display 44 and the battery and pump status and other operational information can be displayed. The user interface is operable to select a mode of operation which would specify one or more of: selection of one or more bladders, a sequence of bladder inflation and deflation in a cycle, time intervals for each inflation and deflation of each bladder within the cycle, pressure/s associated with each inflation and duration at each pressure, and the total number of cycles performed.

As more clearly shown in FIG. 2, the main components of the device 10 are assembled on the upper base plate 16. In these respects, screw or clip fasteners (not shown) may be used. The upper base plate is then connected to lower base plate 14 by way of the aforementioned sealing or clip locking engagement between nipples 32, 34 & 36 and corresponding air pumps 24, 26 and 28. In other embodiments, further screw fasteners may be used.

The lower base plate 14 includes clip formations 52, 54 and 56 for clipping locking engagement with corresponding apertures 58, 60 and 62 in a cover 46 to complete the assembly. This arrangement makes assembly generally quick and easy with no specialised tools required. Component replacement is similarly quick and easy making repairs relatively inexpensive.

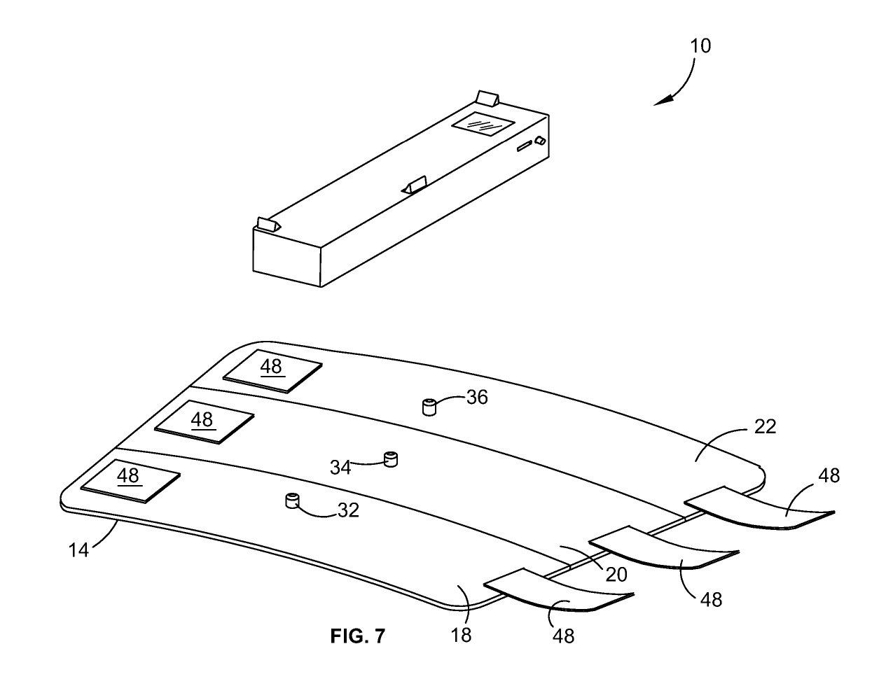

Lower base plate 14, upper base plate 16 and cover 46 are ideally formed from resilient, hygienic plastic materials as is common in the art. The air bladders, which may be in direct skin contact in some applications or in clothing contact in other applications, are formed from separate hygienic and replaceable materials. In the illustrated embodiment, the bladders are formed from non-allergenic, refined vinyl, which is typically used with other medical treatment products. This allows the bladders to be discarded when soiled/damaged and a new bladder or group of interconnected bladders clipped on to the lower base plate 14 as shown on FIG. 7 for replacement at minimal cost.

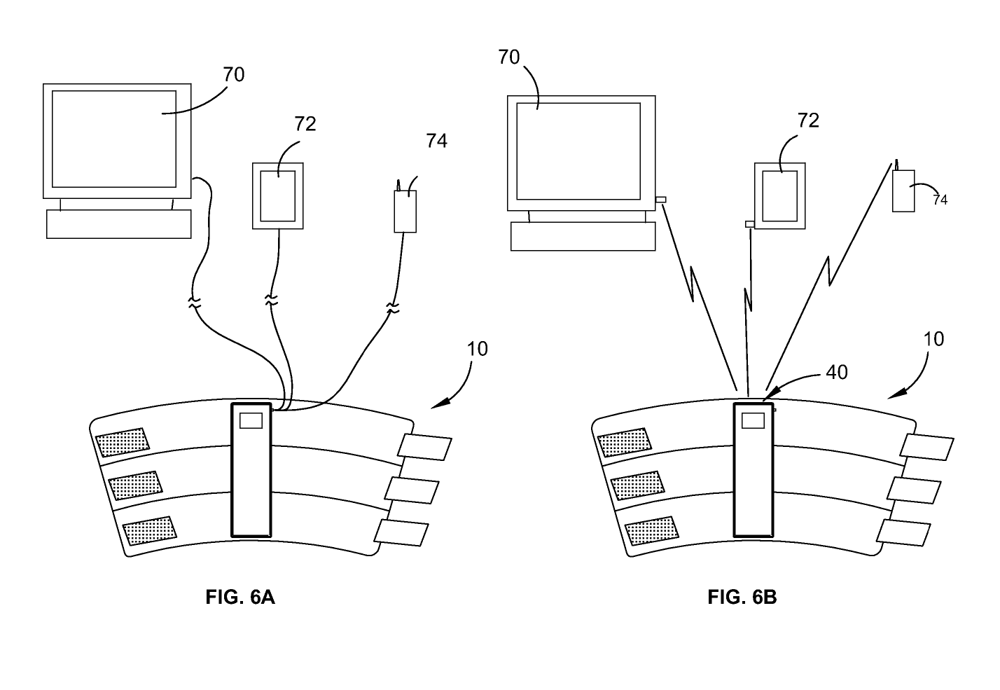

As shown in FIG. 6A and 6B, the device 10 may be adapted for remote or direct communication with a desktop or portable computer 70, tablet 72 or smart phone 74, for direct programming or monitoring. The connection may be direct using a cable as shown in 6A via the above mentioned USB port, or wireless as shown in FIG. 6B using appropriate Wi-Fi or Bluetooth connection protocols. In this way, usage logs may also be uploadable for monitoring by physicians and host PC software programming/configuration of the pump would also be available.

The control system 40 further includes memory storage and the USB port allows logging of usage data to a PC, recorded to an internal 64 Kbytes non-volatile memory, wherein the memory is arranged to store data relating to a mode of operation of the device. As mentioned earlier, a wireless output may also be provided as part of the control system. Further, a clock module may also be provided for time-stamping of usage data.

Pressures sensors (not shown) are also provided as part of the control system 40, and are used to detect pressure levels in the bladders or additionally, blood pressure. The detected pressure levels are compared by the control system with the expected pressure levels, with the control system adjusting the inflation/deflation level of the bladder accordingly. In this way, the device of the present invention further acts as a heart rate monitor and/or blood pressure monitoring system.

According to the invention, the inflation and deflation of each bladder is controlled independently. This advantageously allows each bladder to differ in, for example, the time of inflation of the bladder, the time of deflation of the bladder, and the pressure inside the bladder at any stage of inflation or deflation.

As best shown in FIGS. 1 to 5, the device includes Velcro fastening devices 48 for securing around the patient's limb. However, in other not shown embodiments, buttons, zippers, press studs or any other methods known in the art could be used to secure the bladders in place. In further not shown embodiments, the bladders may be incorporated in a resilient tubular form to allow the insertion of a user's limb there through and no fasteners would be required.

Referring now to FIGS. 3-5, in use, the device is attached to a patient's limb 50 by wrapping the interconnected bladders 18, 20 & 22, so that each bladder extends substantially around its periphery of the user's limb and securing it in position using the Velcro fasteners 48. This is best shown in FIG. 3. Subsequent to securing using the Velcro fasteners 48, the device will be held comfortably in position around the limb 50 as best shown in FIG. 4. In this displayed application, the limb 50 is a calf muscle. As shown, on securing to the limb, the bladders are located adjacent to one another in the longitudinal direction of the limb.

It is proposed that prior to each operation or on start up, the control system 40 performs a self test or calibration cycle. The user operates the user interface to select a desired mode of operation. Moreover, it is proposed that on initial boot safety monitoring is performed.

The mode of operation may be pre-programmed with the requisite variables selected by a user, predetermined by set program, or a combination thereof. It will appreciated that the mode of operation could also be configured to specify the application of a compressive force to a user's limb at specified intervals for specified time periods and at specified pressures.

These variables may include control of one or more of: the time of inflation of the bladder, the time of deflation of the bladder, and the pressure inside the bladder at any stage of inflation or deflation. Preferably, the control system includes a closed loop feedback system to allow regulation of one or more of the above. As mentioned previously, the pressure inside the bladder may be selected to be anywhere in between 10 and 80 mmHg.

Looking further at the proposed modes of operation, in one proposed mode of operation, the application of a steady compressive force is specified at set time intervals. When this mode of operation is performed, all selected bladders will inflate at substantially the same time to a predetermined pressure for a predetermined period of time. The inflation of the selected bladders selectively applies an inwardly directed compressive force to the limb of the user. Following this, the bladders will deflate at a specified rate. A set interval later, this cycle will repeat.

Another mode of operation may specify the application of a pre-programmed or perhaps programmable sequence of contraction intervals and intensities dependent on the needs of the wearer and determined through clinical trials or past research.

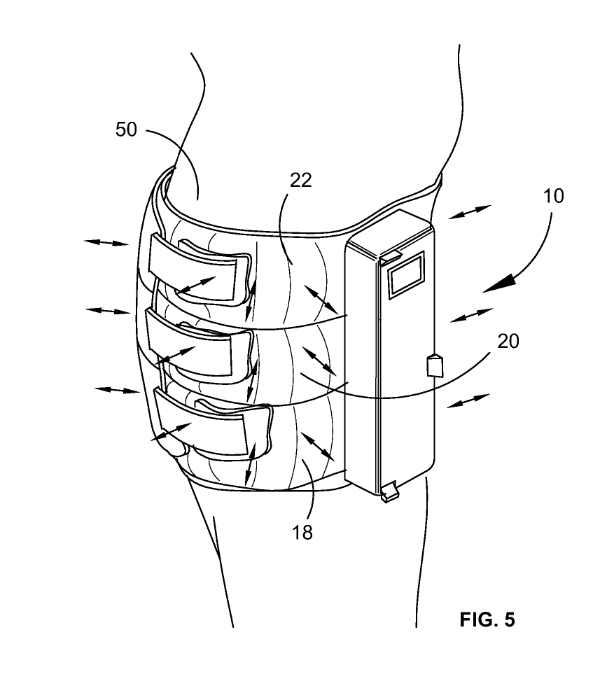

In one preferred mode of operation shown in FIG. 5, the bladders are inflated sequentially. This may involve the inflation of a first bladder 18 and the subsequent inflation of second bladder 20 followed by inflation of the third bladder 22. The subsequent inflation of the second bladder may occur while the first bladder is inflating, inflated, deflating or deflated and similarly with the third bladder.

Sequential inflation of the bladders can be utilised to advantageously apply compression over at least part of a user's limb, whereby compression is applied sequentially upwards so as to encourage venous return and blood flow to the upper portion of the user. Using the device of the present invention in this sequence has an added advantage with respect to the flow integrity not being compromised by bottom bladder holding the pressure till the next two inflate one after the other and deflates from top down. Inflating bottom up and deflate top down advantageously directs the blood flow always towards the heart and away from the ankle.

According to one particular sequence, each bladder sequentially inflates to a predetermined pressure over a period of between 15 and 30 seconds. The bladders remained inflated for approximately 30 seconds and then completely rapidly deflate over 1 to 5 seconds. This cycle then operates for approximately 10 minutes at a time with a five-minute break between for a total of two hours of treatment.

It will be appreciated that the device 10 of the present invention advantageously assists in the treatment of deep vein thrombosis (DVT) or chronic venous disorders (CVD). This rhythmical compression advantageously reduces or eliminates the incidence of DVT in the wearer. It can also be used both in patients after an operation and patients with varicose veins or chronic venous disease or lymphoedema (long term limb swelling). The device 10 may also be used to assist in post operative recovery of orthopedic and abdominal surgeries.

Device 10 is portable and therefore treatment can occur at home or in any location or even during transit. Patients are not restricted in their movement or confined to a bed or hospital stay. Advantageously, this invention has been designed to fit comfortably allowing for the user to continue their daily activities uninhibited. Additionally, the invention is mobile and light weight, making it convenient to use.

Its usage and potentially effectiveness may be uploaded via the internet to be sent the treating doctor so at monitor the patient's progress. It is further proposed that it will be relatively inexpensive to purchase using common materials to manufacture. The device 10 design incorporates pneumatic pressure control and battery management circuitry to mitigate any risk of vascular constriction and fire to the user.

The invention will also be advantageously useful post operatively for knee and hip replacement surgeries in reducing swelling and the need for longer prophylactic low molecular heparin injections.

Although the invention has been described with reference to specific examples, it will be appreciated by those skilled in the art that the invention may be embodied in many other forms.

1. A portable compression device for applying a selective compressive force to a limb of a user, said device including:
two or more individually inflatable bladders; and
a pumping means adapted to selectively inflate and deflate each said bladder thereby selectively applying an inwardly directed compressive force to said limb,
wherein said two or more inflatable bladders and said pumping means being disposed on a base assembly,
wherein said pumping means includes two or more variable speed air pumps each fluidly connected to a respective inflatable bladder.

2. A portable device according to claim 1, wherein said base assembly includes a first base plate and a second base plate.

3. A portable device according to claim 2, wherein said two or more inflatable bladders are disposed on said first base plate.

4. A portable device according to claim 2, wherein said pumping means is disposed on said second base plate.

5. A portable device according to claim 2, including a power means disposed on said second base plate.

6. A portable device according to claim 2, including a control means operatively associated with said pumping means, said control means being located on said second base plate.

7. A portable device according to claim 1, wherein each bladder is adapted for independent inflation and deflation.

8.-9. (canceled)

10. A portable device according to claim 2, wherein each air pump is adapted to variably inflate each or all of the said two or more bladders to a pressure in the range of between 10 and 80 mmHg.

11. A portable device according to claim 1, including one or more valves operatively associated with said pumping means.

12. A portable device according to claim 1, wherein said two or more bladders include three interconnected inflatable bladders.

13. A portable device according to claim 1, wherein, in use, said pumping means is adapted to sequentially inflate each bladder.

14. A portable device according to claim 1, wherein each bladder is adapted to substantially wrap around said limb of said user and apply said compressive force substantially to the periphery of said limb.

15. A portable device according to claim 1, wherein each bladder extends only partially around the periphery of the limb and wherein said bladders are arranged adjacent to one another such that in use adjacent bladders in combination extend substantially around the periphery of said limb.

16. A portable device according to claim 6, wherein said control means includes a user display and user controls. wherein one or more fasteners are used to secure said one or more bladders around said limb.

18. A portable device according to claim 17, wherein said one or more fasteners includes Velcro, buttons, zippers, press studs or a combination thereof.

19. A portable device according to claim 1, wherein said two or more variable speed air pumps includes three variable speed air pumps.
